(19) United States
(12) Patent Application Publication
(10) Pub. No.: US 2005/0161000 A1
(43) Pub. Date: Jul. 28, 2005

(54) Window mounted pet door

(76) Inventor: Crosby S. Noyes, Sorrento, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 11/085,384

(22) Filed: Mar. 21, 2005

Related U.S. Application Data
(63) Continuation-in-part of application No. 10/320,522, filed on Dec. 17, 2002.

(51) Int. Cl. A01K 1/03

(52) U.S. Cl. 119/484

(57) ABSTRACT

A window mounted pet door device. The device is intended to solve problems inherent in the prior art by providing for installation and use of the device in a window, including upper floor windows, without significantly modifying the window unit, thereby increasing the availability of suitable installation locations and appealing to pet owners who do not wish to structurally modify their homes. It also provides a pet access platform component to give a pet a convenient structure for approaching the device when it is installed above ground or floor level. The device may include an automatic door access component and a pet-specific identification component whereby only authorized animals are permitted to access the pet door.

### CROSS REFERENCE TO RELATED APPLICATION

This application is a continuation in part of U.S. Ser. No. 10/320,522, filed Dec. 17, 2002 and currently pending, entitled Window Mounted Automatic Pet Door, which is hereby incorporated by reference.

### BACKGROUND OF THE INVENTION

1. Technical Field

The invention relates generally to the field of pet doors and is directed to a device adapted to be mounted in a window. More specifically, the invention is directed to an improved pet door and pet door mounting device designed to be easily installed and deinstalled in a variety of locations with only minimal structural modification required, with optional features including a system of platforms and ramps to allow pets convenient access to the device and means for allowing only designated pets to use the device.

2. Description of Prior Art

Pet door devices have been well-know in the field. Early pet door devices were mounted in doors or cut into walls, and consisted of a door panel hinged at the top edge and operated by the pet applying a force against the door panel to allow for through passage. While these early devices permitted pets egress and ingress without the need for owner attention, any animal (or even children or intruders) could pass through the pet door. Subsequent designs sought to incorporate various locking mechanisms with corresponding keys, to allow only certain pets access. Other devices employed power, to allow the pet door to be opened and closed without resort to the pet applying a force against the door panel. In all of these designs, however, the pet door device is a permanent fixture; once installed, it cannot be removed without extensive repair work needed.

The prior art discloses various pet door devices. One example of a prior art pet door is disclosed in U.S. Pat. No. 5,967,215 (Needham), issued on Oct. 19, 1999. This patent discloses a one- and two-way pet screen door kit for installation in an existing screen door or window screen. This device uses magnetic latches to control access. It also makes use of a ramp for above-ground installations. This device necessarily involves structural modifications to the screen door or window screen for installation purposes. Other pet door devices disclosed in the prior art include: U.S. Pat. No. 6,141,911 (Reid), issued on Nov. 7, 2000, disclosing a pet door providing access via a door with a locking/unlocking mechanism activated by a pet-specific key device consisting of a tuned receiver and a signal transmitting key; U.S. Pat. No. 5,872,516 (Bonge), issued Feb. 16, 1999, disclosing a remotely operated pet door which automatically opens under its own power when it receives a signal from an ultrasonic transmitter worn by a pet; U.S. Pat. No. 5,177,900 (Solowiej), issued Jan. 12, 1993, disclosing an automatic pet door having a vertically moving door activated by a radiation transmitter worn by the pet; and U.S. Pat. No. 6,297,739 (Small), issued on Oct. 2, 2001, disclosing a powered automatic pet door using a combination of a pet-specific identification device and weight and motion sensors to control access, with the identification device suitable for implantation subcutaneously in the body of the pet. However, each of these prior art devices still necessarily involve structural modifications to a door or wall for installation purposes. None of the foregoing devices utilize a mounting system adapted for easy installation and deinstallation in ordinary windows. Nor do the foregoing devices disclose a platform system enabling pets to access the device when it is mounted in out of the way locations or is otherwise inconvenient to the floor or ground. It is an objective of this invention to provide a new and improved automatic pet door device adapted for window mounting.

Other objectives of this invention will be readily apparent from the description that follows.

### SUMMARY

In one aspect, the invention is directed to a window mounted pet door device. The device is intended to solve problems inherent in the prior art by employing a means for installing and using the device in a window, including upper floor windows, without significantly modifying the window unit, thereby increasing the availability of suitable installation locations and appealing to pet owners who do not wish to structurally modify their homes. The device comprises a casing, a pet access platform component, a window mount component, and a door component, wherein the casing contains a pet access aperture through which a pet may pass, the pet access platform component is situated adjacent to the pet access aperture providing the pet with a platform next to the door on which to stand when the device is located above ground or floor level, the window mount component secures the device to a window and permits operation of both the device and the window, and the door component comprises a door suitably adapted for covering and uncovering the pet access aperture. Optionally, the door component may be automatically operated in conjunction with a pet identification component to permit controlled access through the device.

The device is intended to be used with small pets, such as cats and small dogs, and may be easily installed and deinstalled in different windows as needed, for example both in a primary residence and seasonally in a vacation home. One aspect of the device employs ramps so that access to the device may be had by pets that cannot jump to the level of a window, such as dogs or older or very young cats, or for use in upper floor windows. Another aspect of the device employs a door locking mechanism which retains the door in a closed position across the pet access aperture. The door locking mechanism may be manually operated or operated automatically in conjunction with a pet identification component.

Other features and advantages of the invention are described below.

### DESCRIPTION OF DRAWINGS

FIG. 1 is a perspective view of the device showing the door in a partially opened position with a door block positioned to allow ingress and egress.

FIG. 2 is a side view of the device as mounted in a double hung window. The final position of the sash fasteners and the bottom fasteners are indicated by dotted lines. Optional components including the enclosure, the roof extension, and the ramps are shown with arrows indicating where they attach to the device.

FIG. 3 is a side view of the device as mounted in a double hung window. It depicts the alternate embodiment of the window mount component comprising a leveling bracket.

FIG. 4 is a rear view of the device depicting the door access component.

FIG. 5 is a perspective view of the device showing the housing containing the radio frequency identification component.

FIG. 6 is a perspective view of the device showing the housing containing the control component.

FIG. 7 is a perspective view of the device showing the housing containing the infrared sensing device configured as an “electric eye”.

### DESCRIPTION OF THE INVENTION

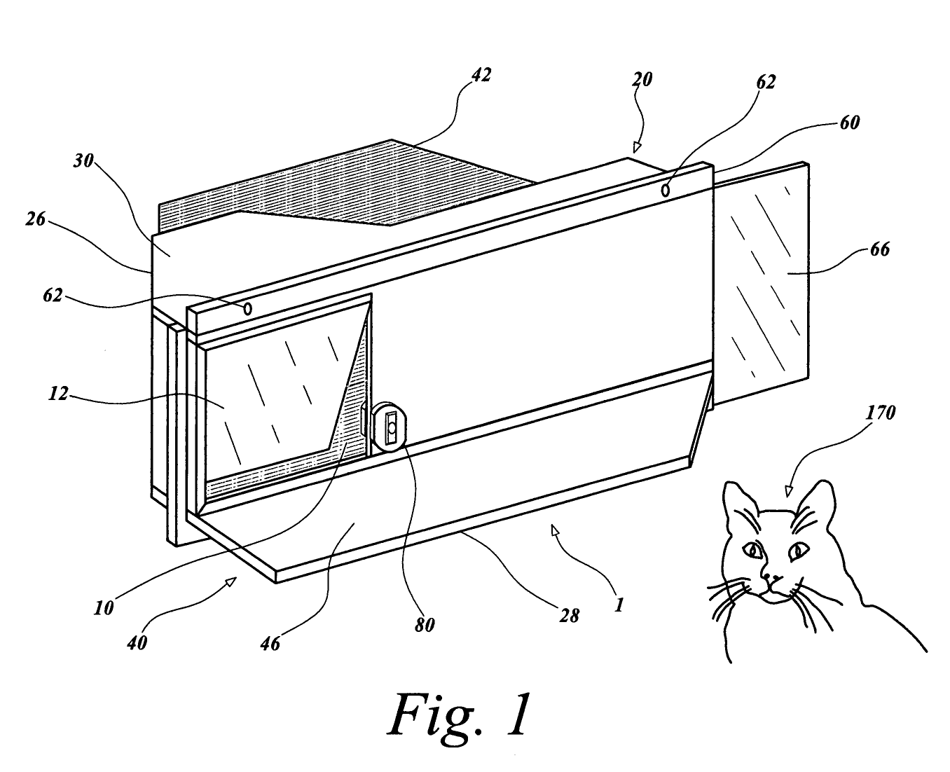

FIG. 1 shows the basic components of the pet door device 1 of the present invention, which include a casing 20, which in turn incorporates a pet access aperture 10 and optionally a housing 21; a door 12 adapted to cover and uncover the pet access aperture 10; a pet access platform component 40; and a window mount component 50. The casing 20 contains the other components, which are integrated into and attached to the casing 20 and/or enclosed within the optional housing 21. The window mount component 50 is adapted to secure the device 1 within a window 180, without necessitating structural modification to the window, walls, or doors, as is necessary with other pet door devices. In one embodiment the window mount component 50 is further adapted to permit operation of the window 180 after mounting the device 1. The window mount component 50 is also adapted to provide weather proofing when the device 1 is in use.

The pet access platform component 40 gives a pet 170 a convenient means for approaching the device 1 when the device 1 is installed above ground or floor level. The device 1 is intended to permit pets to enter or exit a structure, such as a house, garage, or other building, through an existing window 180 while minimizing the impact of this activity on the structure.

The pet access aperture 10 has an uncovered, or open, state, whereby the pet 170 may pass through the pet access aperture 10, and an covered, or closed, state, whereby the pet 170 is prevented from passing through the pet access aperture 10. The door 12 is positioned relative to the pet access aperture 10 to effectuate either the open state or the closed state. The door 12 may be manually positioned by direct contact by the pet 170, or optionally may incorporate a powered door positioning component for moving the door 12 relative to the pet access aperture 10 to allow the pet 170 to pass though the pet access aperture 10 without need too contact the door 12.

The device 1 has an interior portion and an exterior portion. The interior portion of the device 1 is that portion which, when the device 1 is installed in a window 180, is located primarily within the interior of the structure containing the window 180, e.g., “inside the house,” while the exterior portion of the device 1 is that portion which is located primarily exterior to the structure containing the window 180, e.g., “outside the house.” A pet 170 utilizing the device 1 to exit a structure approaches the pet access aperture 10 from the interior portion of the device 1, then passes through the pet access aperture 10, and continues past the exterior portion of the device 1.

The casing 20 is comprised of a top panel 26 and a base panel 28. The top panel 26 is constructed of a rigid material, is substantially planar, is oriented substantially in a horizontal plane, and has an upper surface and a lower surface. The base panel 28 is constructed of a rigid material, is substantially planar, is oriented substantially in a horizontal plane substantially parallel to the top panel 26, and has an upper surface and a lower surface. The top panel 26 provides the point of contact between the device 1 and the sash 184 of a window 180. The base panel 28 provides the point of contact between the device 1 and the base of the window 180.

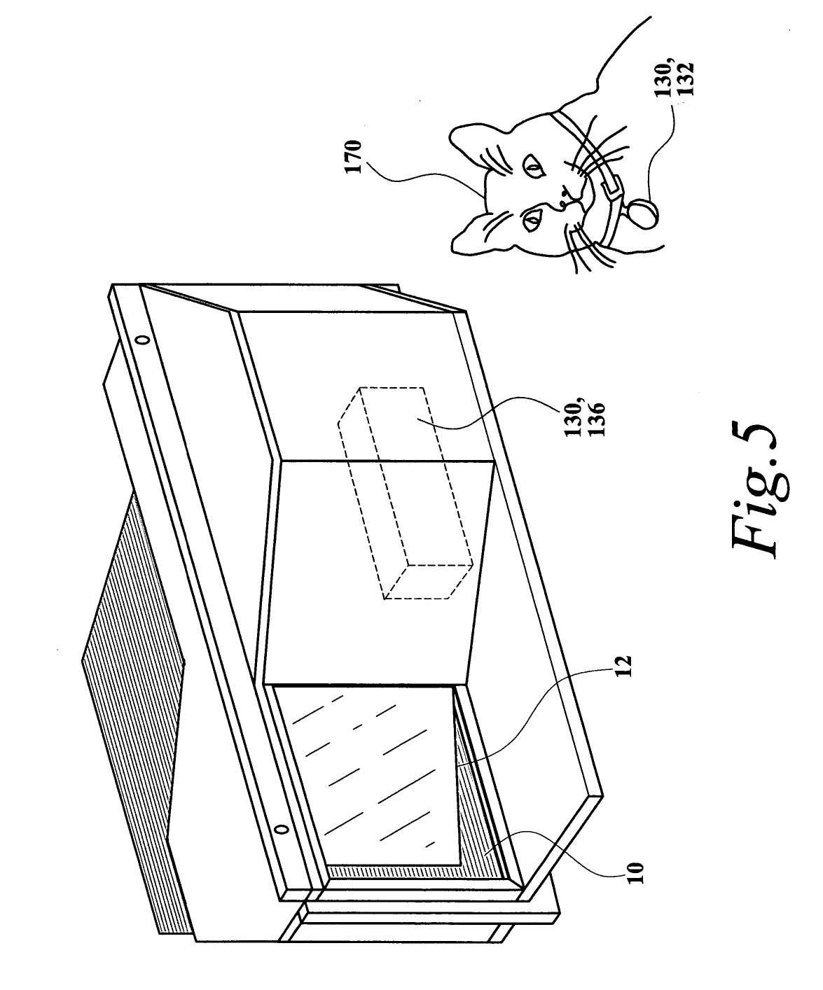

In one embodiment the casing 20 further comprises a housing 21 situated between the top panel 26 and the base panel 28, with the housing 21 being situated within the casing 20 substantially within the interior portion of the casing 20, fixedly attached to the lower surface of the top panel 26 and fixedly attached to the upper surface of the base panel 28. FIG. 5 shows one embodiment of the housing 21. In another embodiment, the housing 21 is comprised of lateral sides constructed of a rigid material and which, together with the top panel 26 and the base panel 28, define a substantially enclosed space. The lateral sides of the housing 21 may be constructed of plexiglass, polystyrene, or other such materials providing strength and rigidity along with being light weight. The housing 21 may be transparent, translucent, tinted, or opaque. In one embodiment the lateral sides of the housing 21 are oriented substantially vertically. One or more of the lateral sides of the housing 21 may be removably attached to the rest of the housing 21, thereby providing access to the interior of the housing 21. The housing 21 is suitably adapted to at least partially contain the optional identification and door access components to shield said components from environmental exposure. In one embodiment, the top panel 26, base panel 28, and optional housing 21 may be constructed of high impact plastic using injection molding methods.

The pet access aperture 10 is situated within the casing 20. In one embodiment the door 12 is planar, is constructed of a rigid material, is of a uniform thickness, is substantially rectangular in shape, and is suitably dimensioned to substantially cover the pet access aperture 10. Other shapes for the door 12 which accomplish the task of completely covering the pet access aperture 10 are also anticipated by this invention. In one embodiment the door 12 is constructed of a transparent, colorless material, thereby giving the pet 170 a clear view through the device 1. In another embodiment of the device 1, the door 12 is constructed of a flexible material. The door 12 may be hinged at the top, allowing the pet 170 to pass through the pet access aperture 10 by pushing the door 12 to a substantially horizontal position and passing underneath. The door 12 may be hinged on the side, allowing the pet 170 to pass through the pet access aperture 10 by pushing the door 12 to the side. The door 12 may retract laterally into the optional housing 21 to allow the pet 170 to pass through the pet access aperture 10.

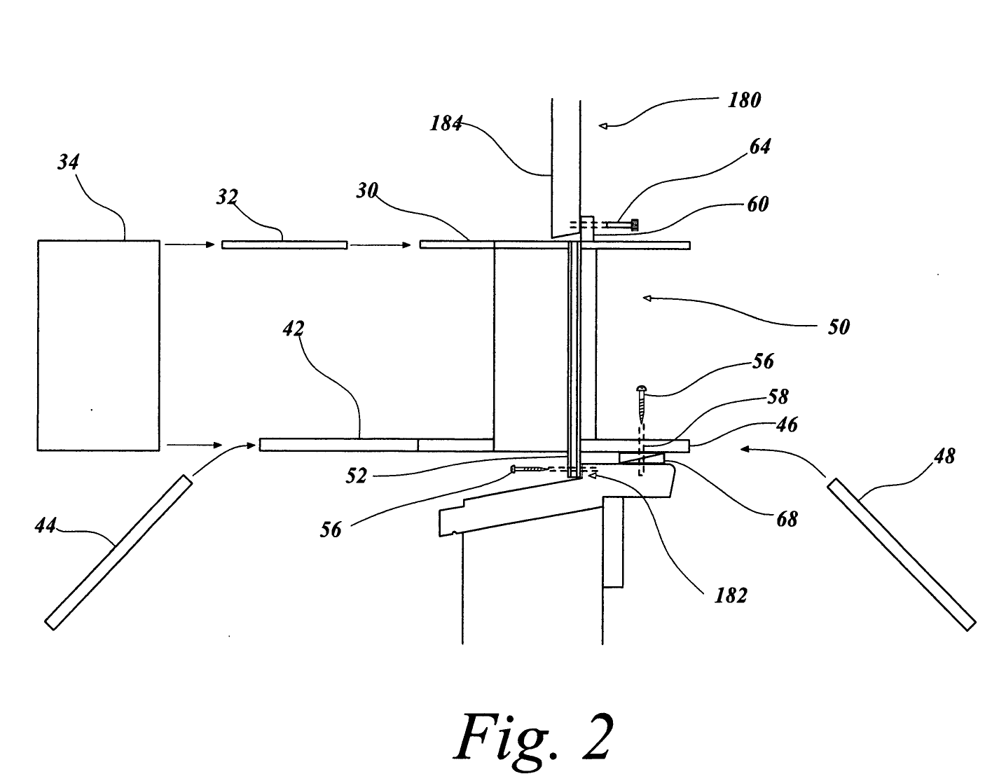

FIG. 2 shows various embodiments of the casing 20 and the pet access platform component 40. In one embodiment, a portion of the top panel 26 is situated above the pet access aperture 10 and extends to the exterior portion of the casing 20, thereby forming an exterior roof 30 over the pet access aperture 10. In yet another embodiment, a portion of the top panel 26 is situated above the pet access aperture 10 and extends to the interior portion of the casing 20, thereby forming an interior roof over the pet access aperture 10. The exterior roof 30 helps keep rain and snow from coming through the pet access aperture 10 when the door 12 is in the open position. In yet another embodiment, the exterior roof 30 further comprises a roof extension 32 removably attached to the exterior roof 30, thereby increasing the weather protection offered by the exterior roof 30. For facilitating shipping and installation of the device 1, the roof extension 32 may be removed.

In another embodiment, the casing 20 further comprises an enclosure 34 removably attached to the exterior portion of the casing 20, such that the enclosure 34 fully encloses the area immediately adjacent to the exterior portion of the casing 20. This feature is useful, for example, in urban areas where a pet 170 is allowed only restricted egress through the device 1 for safety reasons. The enclosure 34 may be suitably dimensioned to accommodate a litter box, and may be suitably adapted to provide fresh air through apertures and viewing opportunities through windows or clear structural elements, such as walls constructed of a transparent material.

The pet access platform component 40 comprises an exterior platform 42 oriented substantially coplanar with the base panel 28 and situated adjacent to and in connection with the base panel 28 on the exterior portion of the casing 20. The exterior platform 42 gives the pet 170 a platform on which to stand when the device 1 is located above ground or floor level. The pet 170 can jump onto the exterior platform 42, and then move towards the pet access aperture 10 to gain entry. In one embodiment the exterior platform 42 is covered by a non-slip material, providing safety to the pet 170. In another embodiment the exterior platform 42 is removably attached to the base panel 28, facilitating shipping and installation of the device 1. If the device 1 is installed at ground or floor level, or there already exists a platform of some sort exterior to the casing 20, the removable exterior platform 42 need not be utilized. In yet another embodiment, the exterior platform 42 further comprises an exterior ramp 44. The exterior ramp 44 is removably attached to the exterior platform 42 and extends to the ground or floor, or to some other stable platform, thereby assisting a pet 170 in gaining access to the device 1. The exterior ramp 44 may come in various sizes and configurations, thereby allowing use of the device 1 in upper story windows.

In another embodiment, the pet access platform component 40 further comprises an interior platform 46, oriented substantially coplanar with the base panel 28 and situated adjacent to and in connection with the base panel 28 on the interior portion of the casing 20. The interior platform 46 gives the pet 170 a platform on which to stand when the device 1 is located above ground or floor level. The pet 170 can jump onto the interior platform 46, and then move towards the pet access aperture 10 to exit. In one embodiment the interior platform 46 is covered by a non-slip material, providing safety to the pet 170. In another embodiment the interior platform 46 is removably attached to the base panel 28, facilitating shipping and installation of the device 1. If the device 1 is installed at ground or floor level, or there already exists a platform of some sort, such as a piece of furniture, interior to the casing 20, the removable interior platform 46 need not be utilized. In yet another embodiment, the interior platform 46 further comprises an interior ramp 48. The interior ramp 48 is removably attached to the interior platform 46 and extends to the floor, or to some other stable platform, thereby assisting a pet 170 in gaining access to the device 1.

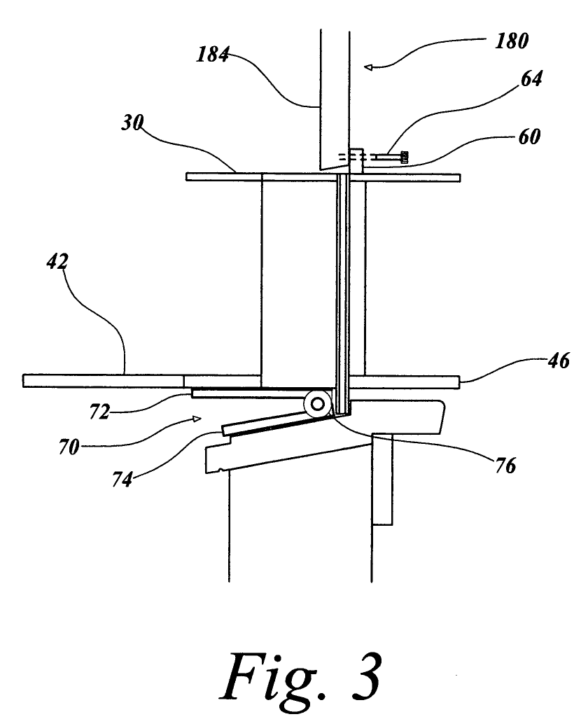

The window mount component 50 is shown in detail in FIGS. 2 and 3. In one embodiment the window mount component 50 may comprise a bottom flange 52 integrated into the lower surface of the base panel 28 and a top flange 60 integrated into the upper surface of the top panel 26. The bottom flange 52 is adapted to fit against and exterior to an interior window stop 182 located on the lower portion of a window 180, such as a stool cap or a sill. Distributed along the length of the bottom flange 52 are a plurality of bottom flange apertures 54 which pass through the bottom flange 52. A plurality of bottom fasteners 56 are adapted to pass through the bottom flange apertures 54 and into the window stop 182. Distributed about the base panel 28 are a plurality of base panel apertures 58 which pass through the base panel 28. A plurality of bottom fasteners 56 are adapted to pass through the base panel apertures 58 and into the window 180. The bottom fasteners 56 secure the device 1 to the window 180 with a minimum of structural modification to the window 180. In one embodiment the bottom fasteners 56 are wood screws. The top flange 60 is adapted to fit against and interior to the lower edge of a window sash 184 of a window 180. Distributed along the length of the top flange 60 are a plurality of top flange apertures 62 which pass through the top flange 60. A plurality of sash fasteners 64 are adapted to pass through the top flange apertures 62 and into the window sash 184, thereby securing the window 180 to the device 1. In one embodiment, the sash fasteners 64 are further adapted to be removably attached to a window sash 184. In this embodiment the sash fasteners 64 may be cylindrical pins. With the sash fasteners 64 in place, passing through the top flange apertures 62 and into the window sash 184, the window 180 is secured in the closed position; with the sash fasteners 64 removed, the window 180 may be raised. Additional support devices may be required to maintain the upper sash 184 of the window 180 in the closed position when the device 1 is installed. Screens, storm windows, and the like, which are situated exterior to the window 180, may be partially raised and then set down on the top panel 26, enabling them to function with the device 1.

The window mount component 50 may further comprises a lateral adaptor panel 66. The lateral adaptor panel 66 is substantially rectangular and has a height substantially equal to the height of the casing 20. It is affixed to the casing 20 and is of a suitable shape and size to cover an opening in the window 180 between the casing 20 and the window frame. The lateral adaptor panel 66 is adapted to permit installation of the device 1 in windows of varying width. In one embodiment the lateral adaptor panel 66 is adjustable, permitting it to be dynamically extended laterally to cover the space between the casing 20 and the window frame. In another embodiment the lateral adaptor panel 66 is delivered as a solid panel to be custom cut by the purchaser to fit the space between the casing 20 and the window frame. In yet another embodiment, the window mount component 50 further comprises a second lateral adaptor panel. The second lateral adaptor panel is substantially rectangular and has a height substantially equal. to the height of the casing 20. It is affixed to the casing 20 on the side of the casing 20 opposite the location of the lateral adaptor panel 66 and adapted to cover an opening in the window 180 between the casing 20 and a window frame on the side of the casing 20 opposite the lateral adaptor panel 66. The use of the second lateral adaptor panel in conjunction with the lateral adaptor panel 66 gives added flexibility in the size of the window 180 in which the device 1 may be installed. In addition, the use of the two panels on either side of the casing 20 results in there being smaller spaces on either side of the casing 20 between the casing 20 and the window frame, rather than one large space on only one side of the casing 20, thereby reducing the risk of a security breach if one or either of the lateral adaptor panels is compromised. In yet another embodiment one or both of the lateral adaptor panels may be constructed of a transparent material.

In yet another embodiment, the window mount component 50 further comprises weather stripping suitably adapted to reduce the incidence of weather passing between the window mount component 50 and the window 180. The weather stripping may consist of rubberized strips, or felt, or any such other suitable material, and should be situated wherever the device 1 is intended to come in contact with the window 180. In one embodiment, the weather stripping is comprised of a rubberized sheet situated along the lower surface of the base panel 28, a rubberized strip affixed to the upper surface of the top panel 26 along side, adjacent, and exterior to the top flange 60, and rubberized strips along the edges of the lateral adaptor panels in contact with the window frame. The weather stripping may also consist of a foam insert to be inserted between the upper and lower sashes of a double hung window 180, thereby reducing the incidence of weather passing between the two window sashes when the device 1 is installed. The presence of the weather stripping serves the additional purpose of acting as a barrier to insects.

In yet another embodiment, the window mount component 50 further comprises one or more shims 68 suitably adapted to fit between the base panel 28 and the window 180. The use of the shims 68 enables the device 1 to be installed securely in a wide range of window designs. In one embodiment the shims 68 are horseshoe shaped. In another embodiment the shims 68 contain apertures adapted to be aligned with the base panel apertures 58 and to accommodate the bottom fasteners, thereby securing the shims 68 in place.

In yet another embodiment, shown in FIG. 3, the window mount component 50 comprises at least one leveling bracket 70 suitably adapted to be fixedly attached to the window 180 and fixedly attached to the base panel 28, thereby securing the device 1 to the window 180. The leveling bracket 70 may further be adjustable such that the device 1 may be installed in a level orientation even when attached to a window 180 which is not level. In one embodiment the leveling bracket 70 has an upper attachment flange 72 and a lower attachment flange 74, with the upper attachment flange 72 movably in connection with the lower attachment flange 74 by a hinge means 76. The upper attachment flange 72 is fixedly attached to the base panel 28 and the lower attachment flange 74 is fixedly attached to the window 180, with the hinge means 76 suitably adapted to fixedly position the upper attachment flange 72 in a desired orientation relative to the lower attachment flange 74. In another embodiment the upper attachment flange 72 contains apertures adapted to be aligned with the base panel apertures 58 and to accommodate the bottom fasteners, thereby securing the upper attachment flange 72 in place.

In one embodiment the device 1 comprises a locking mechanism 80 suitably adapted to retain the door 12 in a closed position to prevent passage through the pet access aperture 10. The locking mechanism 80 may be set by the pet owner to control access through the device 1. Examples of locking mechanisms are well known in the art, including slidable bolts, asymmetric dials, and other physical barriers to door 12 movement. An example of an asymmetric dial locking mechanism 80 is shown in FIG. 1. Said locking mechanism 80 may further be adapted to control passage through the pet access aperture 10 on a limited basis, for example, for egress only or for ingress only, as well as for both ingress and egress or for no passage through the pet access aperture 10.

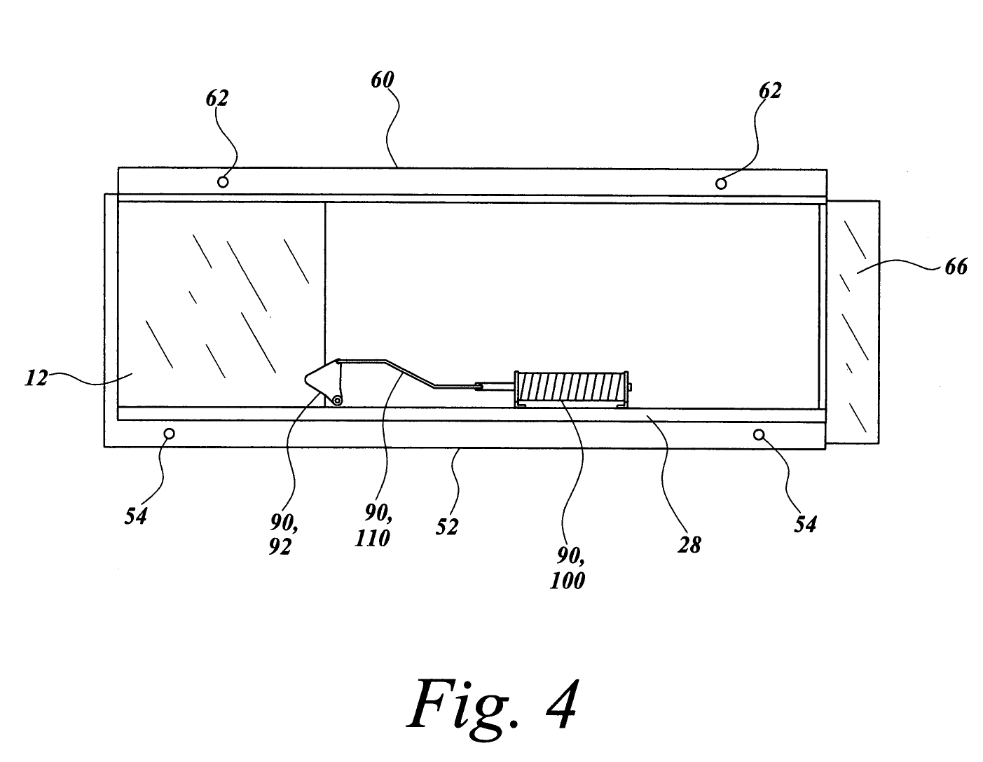

FIGS. 4 through 7 show various embodiments of the door access component 90 of the invention. The door access component 90 comprises a door block 92 which is suitably adapted to prevent movement of the door 12. The door block 92 is positioned by the door access component 90 such that the door block 92 permits the door 12 to be moved to allow the pet 170 to pass through the pet access aperture 10 (the door 12 being in an unlocked state), or prevents the door 12 from moving thereby preventing the pet 170 from passing through the pet access aperture 10 (the door 12 being in a locked state). In one embodiment, the door access component 90 further comprises a powered device 100, such as an electric motor or a solenoid, a power supply in connection with the powered device 100 and adapted to provide power to the powered device 100, a mechanical positioning component 110, and a control component 120. See FIG. 4. The powered device 100, as controlled by the control component 120, causes the mechanical positioning component 110 to move the door block 92 to a first position in which the door 12 is permitted to move, allowing the pet access aperture 10 to become at least partially uncovered such that the pet 170 has access through the pet access aperture 10 (unlocked state), and to a second position preventing the door 12 from being moved, thereby preventing access through the pet access aperture 10 (locked state). The control component 120 controls the mechanical positioning component 110 by a means which activates the powered device 100 in response to inputs from the identification component 130, such that the door block 92 is moved to either the first position or the second position achieving either an unlocked door state or a locked door state, respectively. In another embodiment the door access component 90 may automatically perform a sequence of steps to move the door 12 to uncover the pet access aperture 10 and then move the door 12 to cover the pet access aperture 10.

In one embodiment, the door block 92 consists of a lever which is hingedly attached to the base panel 28 proximate to the pet access aperture 10. The lever is in connection with the powered device 100 by the mechanical positioning component 110. Movement of the mechanical positioning component 110 positions the lever either flush with the surface of the base panel 28, thereby permitting the door 12 to swing freely (unlocked state), or positions the lever above the base panel 28 and within the arc of the door swing in close proximity to the door 12, thereby restricting the swing of the door 12 (locked state). The lever may be retained in either position or may be automatically returned to a default position (either the locked or unlocked state) by the control component 120. In another embodiment, a pair of door blocks are situated one on each side of the pet access aperture 10, thereby allowing for selective direction in the movement of the door 12 and allowing the pet 170 to transit the pet access aperture 10 in only one direction, if desired. The paired door blocks may be levers, as described above, or sliding bolts suitably adapted to be positioned by the mechanical positioning component 110, or any other configuration known in the art for obstructing the free movement of the door 12.

The control component 120 is suitably adapted to receive inputs from the identification component 130 and to initiate a predetermined sequence of events based upon said input from the identification component 130. The predetermined sequence of events includes activation of the powered device 100 and operation of the mechanical positioning component 110 to position one or more door blocks to achieve the desired door state (locked or unlocked). The control component 120 may comprise a timing component to allow for the automatic repositioning of the door block(s) to a default state after a suitable amount of time has elapsed to allow the pet 170 to pass through the pet access aperture 10. The activation of the timing component may be one of the predetermined sequence of events initiated by the control component 120. In one embodiment, the control component 120 comprises a programmable microcontroller which incorporates a registry of pets which are permitted to pass through the pet access aperture 10. If input from the identification component 130 corresponds to data stored in the registry a predetermined sequence of events is initiated by the control component 120 as described above.

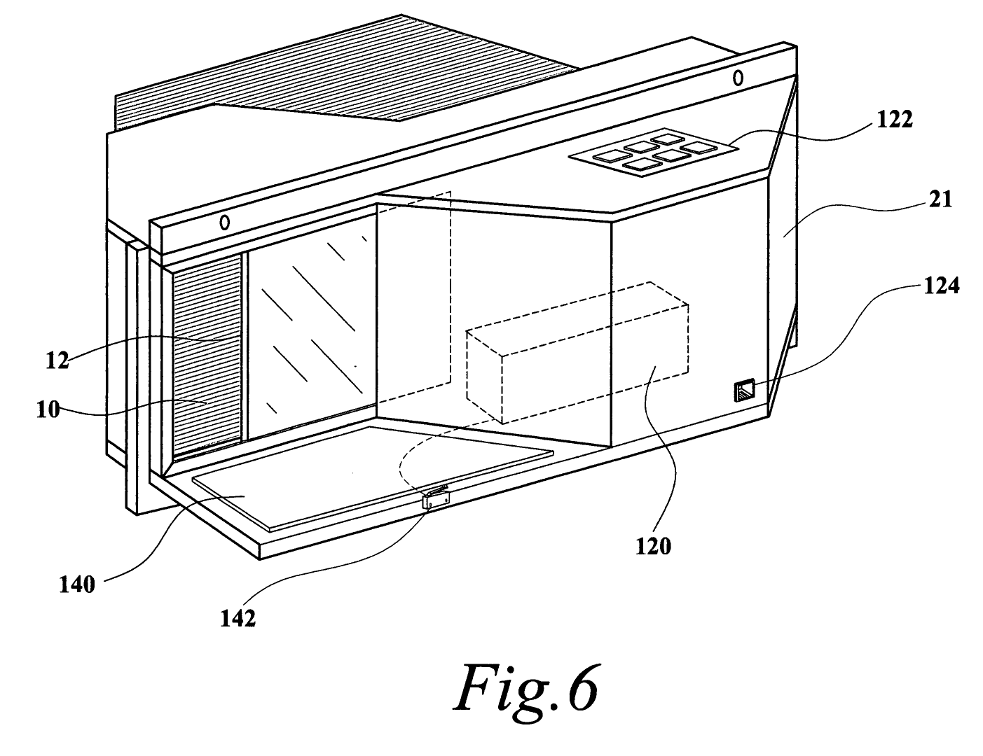

The control component 120 may comprise a data entry device 122, as shown in FIG. 6, situated on the casing 20, and an interface component 124, in connection with the data entry device 122 and suitably adapted to communicate data between the data entry device 122 and the control component 120 to perform control functionality. In this embodiment, the data entry device 122 may be used to set the time-out period of the timing component, to select which of multiple key devices 132 will be permitted access, to establish timing and directional restrictions on an individual pet's access to the device 1, and to control other aspects of the device 1. The data entry device 122 may be configured any number of ways, including having a numeric keypad, or up/down scroll buttons, or other suitable means for accomplishing the desired functionality.

The control component 120 may also comprise an interface component 124 suitably adapted to communicate with a computer for data gathering, processing, and control functionality. Thus, a user may not only modify control aspects of the device 1, but can also gather and analyze data concerning the use patterns of the device 1 by authorized pets. Utilizing the functionality of the internet, the interface component 124 may allow control and monitoring of the device 1 from remote locations, such as when a pet owner is on vacation.

The identification component 130 discerns between individual animals and permits access to designated pets under predetermined conditions through the pet access aperture 10 by activating the door access component 90. The identification component 130 may be configured to accept only certain individual pets, or to permit passage of the pet 170 through the pet access aperture 10 in only one direction (e.g., only to let the pet 170 in or only to let the pet 170 out), or to limit the time periods during which the pet 170 may activate the door 12, or any combination of the foregoing.

In one embodiment, shown in FIG. 5, the identification component 130 comprises a key device 132, also known as a transponder, adapted to be carried by the pet 170 and suitably adapted to transmit a radio signal in an identifiable manner, and a radio frequency identification component 136, also known as an interrogator or reader, situated substantially within the housing 21 and suitably adapted to transmit and receive radio signals a short distance exterior to the housing 21 and in near proximity to the door 12. In this embodiment, the identification component 130 is adapted to be activated when the pet 170 carrying the key device 132 comes within a predetermined near proximity to the pet access aperture 10; when such occurs, the identification component 130 resolves whether the pet 170 is permitted access, and if so, activates the door access component 90. The key device 132 is energized by the radio signals transmitted by the radio frequency identification component 136; it therefore does not need its own independent power supply. The combination of a key device 132 and a radio frequency identification component 136 is well known in the industry. In one embodiment, the radio frequency identification component 136 is adapted to generate a weak radio signal with an effective range of a few inches of the door 12. An antenna monitors for the presence of radio signals generated by the key device 132. When the key device 132 is brought within the field of the radio signals, it is energized by the radio signals transmitted by the radio frequency identification component 136 and in turn transmits its own signal, which is received by the radio frequency identification component 136. The radio frequency identification component 136 compares the radio signal from the key device 132 against a predetermined selection; a match indicates that the key device 132 corresponds to an authorized pet 170 and the door access sequence is initiated. Multiple key devices 132 may be used with the device 1. A new key device 132 is initialized by placing it within the field of radio signals transmitted by the radio frequency identification component 136 and causing the radio frequency identification component 136 to register the key device 132 for future identification. In one embodiment the key device 132 is a collar tag to be worn by the pet 170. In another embodiment the key device 132 may be a subcutaneous implant. Thus, other pets wearing similar key devices 132 can be screened, and access to the device 1 can be accurately controlled to the individual pet 170. Other embodiments of the radio frequency identification component 136 may be utilized in the device 1, provided the function of individual pet identification is met.

In another embodiment, shown in FIG. 6, the identification component 130 further comprises a pressure plate 140 and a microswitch 142. The pressure plate 140 is spring-mounted onto the pet access platform component 40 proximate to the door 12, such that the application of a downward force on the pressure plate 140 causes the pressure plate 140 to move downward towards the pet access platform component 40 and the removal of the downward force allows the pressure plate 140 to move upward away from the pet access platform component 40. The microswitch 142 is situated on the pet access platform component 40 below the pressure plate 140, is in connection with the door access component 90, and is suitably adapted to send a signal to the door access component 90 when activated. The application of a sufficient downward force to the pressure plate 140 causes the pressure plate 140 to move downwards until it contacts the microswitch 142, which then initiates the door access sequence. Such a downward force is calibrated to approximate the weight of a small pet 170 standing on the pressure plate 140.

In yet another embodiment, the identification component 130 further comprises a magnetic key 132, adapted to be carried by a pet 170, and a switch suitably adapted to be activated by a magnetic field and suitably adapted to activate the door access component 90.

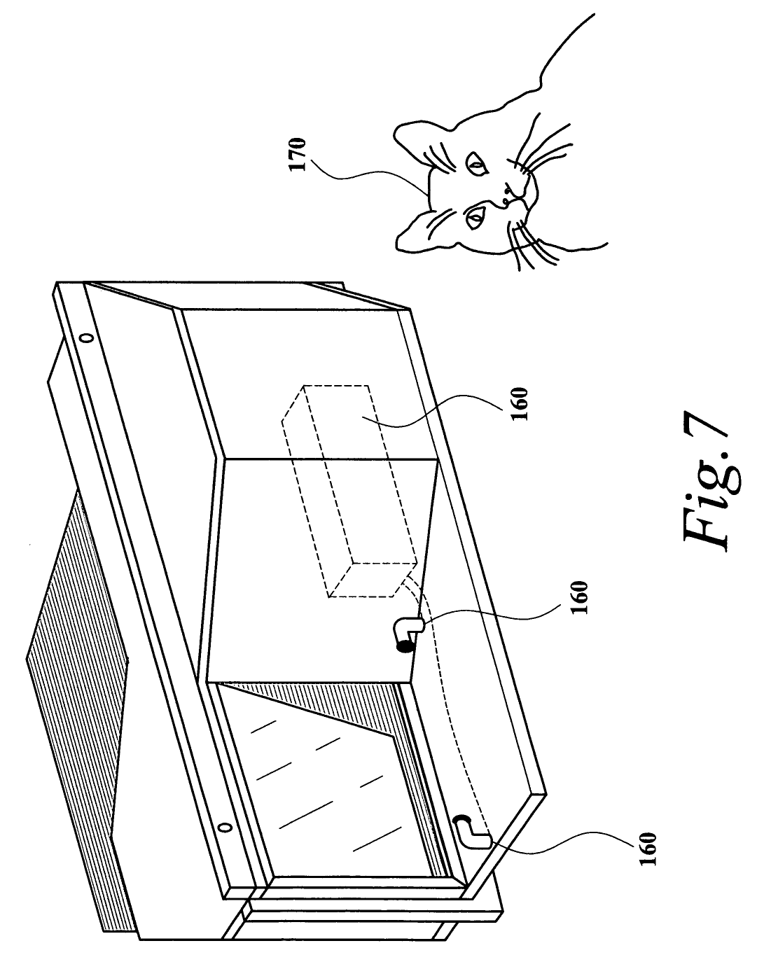

In yet another embodiment, the identification component 130 further comprises an infrared sensing device 160, situated substantially within the housing 21. The infrared sensing device 160 may be activated by a key device 132 adapted to be carried by the pet 170 and suitably adapted to be recognized by the infrared sensing device 160, for example by the infrared sensing device 160 being adapted to respond to reflected light given off by a number of discreet colors present on the key device 132. The pet 170 would wear a collar hang tag which incorporated one of these discreet colors and the colored tag would be positioned in such a manner so when the pet 170 presented itself for passage through the pet access aperture 10 it would be identified by the infrared sensing device 160, thus allowing differentiation between different pets. In yet another embodiment, the infrared sensing device 160 may be suitably adapted to detect temperature variation that the pet 170 presenting itself for passage through the pet access aperture 10 would emit. The infrared sensing device 160 could also be used in conjunction with an infrared emitter. In such case, the infrared sensing device 160 would respond to the presence of the pet 170 by sensing the infrared light reflected off the pet 170 as it approached the pet access aperture 10. An infrared sensing device 160 and emitter could also be placed opposite each other in a manner such that the passage of the pet 170 between these two components would cause the interruption of the reception of the light source by the infrared sensing device 160, thus indicating the presence of the pet 170 (i.e., functioning as an “electric eye”), as shown in FIG. 7. Other applications of infrared sensing devices known in the art are also contemplated by the present invention.

As described, the present invention is an improved design for a pet access device 1 over the prior art. It allows installation in a window 180, thereby avoiding the major structural modification requirements of prior art designs, as well as allowing easy portability, from room to room as needed or even from house to vacation home, for example, if the pet 170 resides in different seasonal locations. The device 1 may incorporate a pet-specific identification component 130 to better restrict access to only authorized pets. The pet access platform component 40 and the available ramp system allows installation of the device 1 in otherwise inconvenient locations, increasing its utility to the pet owner.

Modifications and variations can be made to the disclosed embodiments of the device 1 without departing from the subject or spirit of the device 1 as defined in the following claims.

1. A pet door device, comprising
a casing;
a pet access platform component; and
a window mount component;
wherein the casing contains a pet access aperture through which a pet may pass and a movable door, said door suitably adapted to substantially cover the pet access aperture when the door is in a closed position and suitably adapted to uncover the pet access aperture when the door is in an open position, and
the pet access platform component is situated adjacent to the pet access aperture providing the pet with a platform next to the door on which to stand.

2. The device of claim 1, wherein the casing further comprises
an exterior portion;
an interior portion;
a top panel having an upper surface and a lower surface; and
a base panel having has an upper surface and a lower surface;
wherein the top panel is planar, is constructed of a rigid material, and is oriented in a substantially horizontal plane,
the base panel is planar, is constructed of a rigid material, and is oriented in a substantially horizontal plane parallel to the top panel, with the base panel being situated below the top panel, and
the pet access aperture is situated within the casing between the top panel and the base panel.

3. The device of claim 2, wherein a portion of the top panel situated above the pet access aperture extends to the exterior portion of the casing to form an exterior roof over the pet access aperture.

4. The device of claim 3, wherein the exterior roof further comprises a roof extension removably attached to the exterior roof.

5. The device of claim 2, wherein the casing further comprises an enclosure removably attached to the exterior portion of the casing wherein the enclosure fully encloses an area immediately adjacent to the exterior portion of the casing thereby restricting the pet to said area.

6. The device of claim 2, wherein the pet access platform component comprises an exterior platform oriented coplanar with the base panel and situated adjacent to and in connection with the base panel on the exterior portion of the casing.

7. The device of claim 6, wherein the exterior platform is removably attached to the base panel.

8. The device of claim 6, wherein the exterior platform further comprises an exterior ramp removably attached to the exterior platform.

9. The device of claim 2, wherein the pet access platform component further comprises an interior platform oriented coplanar with the base panel and situated adjacent to and in connection with the base panel on the interior portion of the casing.

10. The device of claim 9, wherein the interior platform is removably attached to the base panel.

11. The device of claim 9, wherein the interior platform further comprises an interior ramp removably attached to the interior platform.

12. The device of claim 2, wherein the window mount component comprises
a bottom flange integrated into the lower surface of the base panel and adapted to fit against a window stop of a window;
a plurality of base panel apertures passing through the base panel;
a plurality of bottom flange apertures passing through the bottom flange;
a plurality of bottom fasteners 56 adapted to pass through the base panel apertures and through the bottom flange apertures and into the window;
a top flange integrated into the upper surface of the top panel and adapted to fit against a window sash of the window;
a plurality of top flange apertures passing through the top flange;
a plurality of sash fasteners adapted to pass through the top flange apertures and into the window sash; and
a lateral adaptor panel, being substantially rectangular and having a height substantially equal to a height of the casing, being in connection with the casing and adapted to cover an opening in the window between the casing and a window frame.

13. The device of claim 12, wherein the sash fasteners are further adapted to be removably attached to the window sash.

14. The device of claim 12, wherein the lateral adaptor panel is adjustable.

15. The device of claim 12, wherein the window mount component further comprises weather stripping.

16. The device of claim 12, wherein the window mount component further comprises at least one shim suitably adapted to fit between the base panel and the window.

17. The device of claim 2, wherein the window mount component comprises at least one leveling bracket suitably adapted to be fixedly attached to the window and fixedly attached to the base panel.

18. The device of claim 17, wherein the leveling bracket comprising
an upper attachment flange;
a lower attachment flange; and
a hinge means,
wherein the upper attachment flange is movably in connection with the lower attachment flange by said hinge means, the upper attachment flange is fixedly attached to the base panel, the lower attachment flange is fixedly attached to the window, and the hinge means is suitably adapted to fixedly position the upper attachment flange in a desired orientation relative to the lower attachment flange.

19. The device of claim 1 further comprising a locking mechanism suitably adapted to retain the door in a closed position and to release the door to permit movement of said door relative to the pet access aperture, whereby the pet access aperture may be accessed by the pet.

20. The device of claim 2 further comprising
a door access component, comprising a door block;
an identification component; and
a housing;
whereby the door access component is electrically powered, is activated by the pet, and positions the door block with respect to the door, whereby said door block permits the door to be moved or prevents the door from moving,
the identification component discerns between individual animals and permits access to designated pets under predetermined conditions through the pet access aperture by controlling the door access component, and
the housing is fixedly attached to the lower surface of the top panel and fixedly attached to the upper surface of the base panel and is suitably adapted to at least partially contain the door access component and the identification component.

21. The device of claim 20, wherein the door access component further comprises
a powered device being fixedly attached to the upper surface of the base panel substantially within the housing;
a power supply, in connection with the powered device and adapted to provide power to the powered device;
a mechanical positioning component; and
a control component;
whereby the powered device, as controlled by the control component, causes the mechanical positioning component to move the door block to a first position in which the door is permitted to move, allowing the pet access aperture to become at least partially uncovered such that the pet has access through the pet access aperture, and to a second position preventing the door from being moved, thereby preventing access through the pet access aperture.

22. The device of claim 21, wherein the mechanical positioning component comprises
a means for connecting the door block to the powered device,
a means for retaining the door block in the first position,
a means for retaining the door block in the second position, and
a means for causing the door block to transition between the first and second positions.

23. The device of claim 21, wherein the control component comprises
a means for activating the powered device in response to inputs from the identification component such that the door block is moved to either the first position or the second position.

24. The device of claim 23, wherein the control component further comprises
a data entry device, situated on the casing; and
an interface component, in connection with the data entry device and suitably adapted to communicate data between the data entry device and the control component.

25. The device of claim 23, wherein the control component further comprises
an interface component suitably adapted to communicate with a computer.

26. The device of claim 20, wherein the identification component comprises
a key device adapted to be carried by the pet and suitably adapted to transmit an identifiable radio signal; and
a radio frequency identification component suitably adapted to transmit and receive radio signals and to identify the radio signal transmitted by the key device.

27. The device of claim 20, wherein the identification component comprises
a pressure plate, spring-mounted onto the pet access platform component such that the application of a downward force on the pressure plate causes the pressure plate to move downward towards the pet access platform component and the removal of the downward force allows the pressure plate to move upward away from the pet access platform component; and
a microswitch, situated on the pet access platform component below the pressure plate and in connection with the door access component;
wherein the microswitch is suitably adapted to signal the door access component when the downward force applied to the pressure plate is sufficient to cause the pressure plate to make contact with the microswitch.

28. The device of claim 20, wherein the identification component comprises
a magnetic key, adapted to be carried by a pet; and
a switch suitably adapted to be activated by a magnetic field and suitably adapted to activate the door access component.

29. The device of claim 20, wherein the identification component comprises
an infrared sensing device.

30. The device of claim 29, wherein the identification component further comprises
a key device adapted to be carried by the pet and suitably adapted to be recognized by the infrared sensing device.
